(19) United States
(12) Patent Application Publication
(10) Pub. No.: US 2023/0246767 A1
(43) Pub. Date: Aug. 3, 2023

(54) METHOD, APPARATUS AND COMPUTER PROGRAM FOR ENABLING A COMMUNICATION SESSION

(71) Applicant: Nokia Technologies Oy, Espoo (FI)

(72) Inventors: Rainer LIEBHART, Munich (DE); Peter LEIS, Penzberg (DE); Sung Hwan WON, Flower Mound, TX (US)

(21) Appl. No.: 18/007,085

(22) PCT Filed: Jul. 31, 2020
(86) PCT No.: PCT/EP2020/071677

§ 371 Date: Jan. 27, 2023

(51) Int. Cl. H04L 5/00

(52) U.S. Cl. CPC H04L 5/0048; H04L 5/0005

(57) ABSTRACT

There is provided an apparatus, said apparatus comprising means for receiving an indication of an identifier of a group comprising one or more user equipments, providing the indication of the identifier of the group to a first network function and selecting a second network function for use by a user equipment of the group based on the indication of the identifier of the group.

### FIELD

The present application relates to a method, apparatus, and computer program and in particular but not exclusively to network function selection.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices (also referred to as station or user equipment) and/or application servers. The communication sessions may comprise, for example, communication of data for carrying communications such as voice, video, electronic mail (email), text message, multimedia, content data, time-sensitive network (TSN) flows and/or data in an industrial application such as critical system messages between an actuator and a controller, critical sensor data (such as measurements, video feed etc.) towards a control system and so on. Non-limiting examples of services provided comprise two-way or multi-way calls, data communication or multimedia services and access to a data network system, such as the Internet.

In a wireless communication system at least a part of a communication session, for example, between at least two stations or between at least one station and at least one application server (e.g. for video), occurs over a wireless link. Examples of wireless systems comprise public land mobile networks (PLMN) operating based on 3GPP radio standards such as E-UTRA, New Radio, satellite based communication systems and different wireless local networks, for example wireless local area networks (WLAN). The wireless systems can typically be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access one or more carriers provided by the network, for example a base station of a cell, and transmit and/or receive communications on the one or more carriers. In carrier aggregation (CA) two or more carriers are combined into one channel. In dual connectivity (DC), two carriers from different sites are combined, that is a user equipment may be dual (or multi) connected to two (or more) sites.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) based on the E-UTRAN radio-access technology, and so-called 5G system (5GS) including the 5G or next generation core (NGC) and the 5G Access network based on the New Radio (NR) radio-access technology. 5GS including NR are being standardized by the 3rd Generation Partnership Project (3GPP).

### SUMMARY

In a first aspect there is provided an apparatus, said apparatus comprising means for receiving an indication of an identifier of a group comprising one or more user equipments, providing the indication of the identifier of the group to a first network function and selecting a second network function for use by a user equipment of the group based on the indication of the identifier of the group.

The apparatus may comprise means for providing a discovery request including the indication of the identifier of the group to the first network function, receiving a profile of the second network function or context data of one user equipment of the group from the first network function and selecting the second network function based on the profile or the context data.

The indication of the identifier of the group may be received in a session establishment request from one user equipment of the group or the indication of the identifier of the group may be received from a network function during a registration procedure of one user equipment of the group.

The apparatus may comprise means for receiving the indication of the identifier from one of a unified data management, the user equipment, an unmanned aerial system, UAS, UAS Service Supplier, a UAS Application Server and a UAS Traffic Management.

The apparatus may comprise means for receiving at least one of an indication of a communication session type and the location of the user equipment.

The apparatus may comprise means for selecting the second network function for use by the user equipment based on at least one of the communication session type and the location of the user equipment.

The group may comprise one or more of an unmanned aerial vehicle, unmanned aerial vehicle controller and an unmanned aerial system, UAS.

The first network function may be a network repository function or an unstructured data storage function.

The second network function may comprise a session management function or a user plane function.

When the second network function is a user plane function, it may comprise a traffic filter policy.

In a second aspect there is provided an apparatus comprising means for receiving at a first network function an indication of an identifier of a group comprising one or more user equipments for use in selecting a second network function for use by a user equipment of the group.

The apparatus may comprise means for receiving a discovery request including the indication of the identifier of the group from a third network function, determining a profile of the second network function or context data of one user equipment of the group based on the recovery request and providing the profile of the second network function or context data of one user equipment of the group to the third network function.

The first network function may be a network repository function and comprise means for storing the identifier in the profile of the second network function or in a table.

The first network function is an unstructured data storage function and comprise means for storing the identifier in user equipment context data or in a table.

The second network function may comprise one of a user plane function and a session management function.

The third network function may comprise an access and mobility management function.

In a third aspect there is provided a method comprising receiving an indication of an identifier of a group comprising one or more user equipments, providing the indication of the identifier of the group to a first network function and selecting a second network function for use by a user equipment of the group based on the indication of the identifier of the group.

The method may comprise providing a discovery request including the indication of the identifier of the group to the first network function, receiving a profile of the second network function or context data of one user equipment of the group from the first network function and selecting the second network function based on the profile or the context data.

The indication of the identifier of the group may be received in a session establishment request from one user equipment of the group or the indication of the identifier of the group may be received from a network function during a registration procedure of one user equipment of the group.

The method may comprise receiving the indication of the identifier from one of a unified data management, the user equipment, an unmanned aerial system, UAS, UAS Service Supplier, a UAS Application Server and a UAS Traffic Management.

The method may comprise receiving at least one of an indication of a communication session type and the location of the user equipment.

The method may comprise selecting the second network function for use by the user equipment based on at least one of the communication session type and the location of the user equipment.

The group may comprise one or more of an unmanned aerial vehicle, unmanned aerial vehicle controller and an unmanned aerial system, UAS.

The first network function may be a network repository function or an unstructured data storage function.

The second network function may comprise a session management function or a user plane function.

When the second network function is a user plane function, it may comprise a traffic filter policy.

In a fourth aspect there is provided a method comprising receiving at a first network function an indication of an identifier of a group comprising one or more user equipments for use in selecting a second network function for use by a user equipment of the group.

The method may comprise receiving a discovery request including the indication of the identifier of the group from a third network function, determining a profile of the second network function or context data of one user equipment of the group based on the recovery request and providing the profile of the second network function or context data of one user equipment of the group to the third network function.

The first network function may be a network repository function and the method may comprise storing the identifier in the profile of the second network function or in a table.

The first network function is an unstructured data storage function and the method may comprise storing the identifier in user equipment context data or in a table.

The second network function may comprise one of a user plane function and a session management function.

The third network function may comprise an access and mobility management function.

In a fifth aspect there is provided an apparatus comprising: at least one processor and at least one memory including a computer program code, the at least one memory and computer program code configured to, with the at least one processor, cause the apparatus at least to: receive an indication of an identifier of a group comprising one or more user equipments, provide the indication of the identifier of the group to a first network function and select a second network function for use by a user equipment based on the indication of the identifier of the group.

The apparatus may be configured to provide a discovery request including the indication of the identifier of the group to the first network function, receive a profile of the second network function or context data of one user equipment of the group from the first network function and select the second network function based on the profile or the context data.

The indication of the identifier of the group may be received in a session establishment request from one user equipment of the group or the indication of the identifier of the group may be received from a network function during a registration procedure of one user equipment of the group.

The apparatus may be configured to receive the indication of the identifier from one of a unified data management, the user equipment, an unmanned aerial system, UAS, UAS Service Supplier, a UAS Application Server and a UAS Traffic Management.

The apparatus may be configured to receive at least one of an indication of a communication session type and the location of the user equipment.

The apparatus may be configured to select the second network function for use by the user equipment based on at least one of the communication session type and the location of the user equipment.

The group may comprise one or more of an unmanned aerial vehicle, unmanned aerial vehicle controller and an unmanned aerial system, UAS.

The first network function may be a network repository function or an unstructured data storage function.

The second network function may comprise a session management function or a user plane function.

When the second network function is a user plane function, it may comprise a traffic filter policy.

In a sixth aspect there is provided an apparatus comprising: at least one processor and at least one memory including a computer program code, the at least one memory and computer program code configured to, with the at least one processor, cause the apparatus at least to receive at a first network function an indication of an identifier of a group comprising one or more user equipments for use in selecting a second network function for use by a user equipment.

The apparatus may be configured to receive a discovery request including the indication of the identifier of the group from a third network function, determine a profile of the second network function or context data of one user equipment of the group based on the recovery request and provide the profile of the second network function or context data of one user equipment of the group to the third network function.

The first network function may be a network repository function and configured to store the identifier in the profile of the second network function or in a table.

The first network function is an unstructured data storage function and configured to store the identifier in user equipment context data or in a table.

The second network function may comprise one of a user plane function and a session management function.

The third network function may comprise an access and mobility management function.

In a seventh aspect there is provided a computer readable medium comprising program instructions for causing an apparatus to perform at least the following receiving an indication of an identifier of a group comprising one or more user equipments, providing the indication of the identifier of the group to a first network function and selecting a second network function for use by a user equipment based on the indication of the identifier of the group.

The apparatus may be caused to perform providing a discovery request including the indication of the identifier of the group to the first network function, receiving a profile of the second network function or context data of one user equipment of the group from the first network function and selecting the second network function based on the profile or the context data.

The indication of the identifier of the group may be received in a session establishment request from one user equipment of the group or the indication of the identifier of the group may be received from a network function during a registration procedure of one user equipment of the group.

The apparatus may be caused to perform receiving the indication of the identifier from one of a unified data management, the user equipment, an unmanned aerial system, UAS, UAS Service Supplier, a UAS Application Server and a UAS Traffic Management.

The apparatus may be caused to perform receiving at least one of an indication of a communication session type and the location of the user equipment.

The apparatus may be caused to perform selecting the second network function for use by the user equipment based on at least one of the communication session type and the location of the user equipment.

The group may comprise one or more of an unmanned aerial vehicle, unmanned aerial vehicle controller and an unmanned aerial system, UAS.

The first network function may be a network repository function or an unstructured data storage function.

The second network function may comprise a session management function or a user plane function.

When the second network function is a user plane function, it may comprise a traffic filter policy.

In an eighth aspect there is provided a computer readable medium comprising program instructions for causing an apparatus to perform at least the following receiving at a first network function an indication of an identifier of a group comprising one or more user equipments for use in selecting a second network function for use by a user equipment.

The apparatus may be caused to perform receiving a discovery request including the indication of the identifier of the group from a third network function, determining a profile of the second network function or context data of one user equipment of the group based on the recovery request and providing the profile of the second network function or context data of one user equipment of the group to the third network function.

The first network function may be a network repository function and be caused to perform storing the identifier in the profile of the second network function or in a table.

The first network function is an unstructured data storage function and be caused to perform storing the identifier in user equipment context data or in a table.

The second network function may comprise one of a user plane function and a session management function.

The third network function may comprise an access and mobility management function.

In a ninth aspect there is provided a non-transitory computer readable medium comprising program instructions for causing an apparatus to perform at least the method according to the third aspect or a method according to the fourth aspect.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example communication system comprising a base station and a plurality of communication devices;

FIG. 2 shows a schematic diagram of an example mobile communication device;

FIG. 3 shows a schematic diagram of an example control apparatus;

FIG. 4 shows a schematic diagram of an example UAV architecture in a 3GPP system;

FIG. 5 shows a flowchart of a method according to an example embodiment;

FIG. 6 shows a flowchart of a method according to an example embodiment;

FIG. 7 shows a signalling flow according to an example embodiment;

FIG. 8 shows a signalling flow according to an example embodiment.

### DETAILED DESCRIPTION

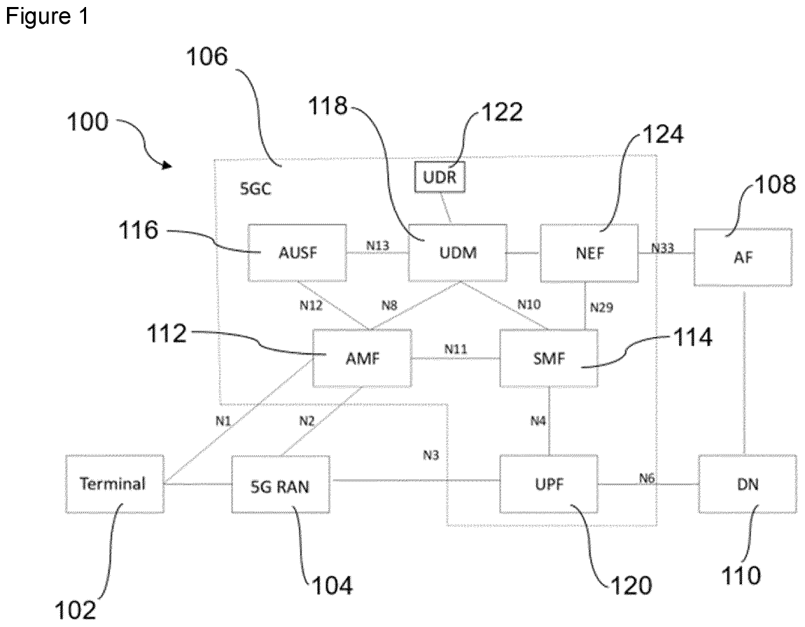

Before explaining in detail the examples, certain general principles of a wireless communication system and mobile communication devices are briefly explained with reference to FIGS. 1 to 3 to assist in understanding the technology underlying the described examples.

An example of a suitable communications system is the 5G System (5GS). Network architecture in 5GS may be similar to that of LTE-advanced. Base stations of NR systems may be known as next generation Node Bs (gNBs). Changes to the network architecture may depend on the need to support various radio technologies and finer QoS support, and some on-demand requirements for e.g. QoS levels to support QoE of user point of view. Also network aware services and applications, and service and application aware networks may bring changes to the architecture. Those are related to Information Centric Network (ICN) and User-Centric Content Delivery Network (UC-CDN) approaches. NR may use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

FIG. 1 shows a schematic representation of a 5G system (5GS) 100. The 5GS may comprise a user equipment (UE) 102 (which may also be referred to as a communication device or a terminal), a 5G radio access network (5GRAN) 104, a 5G core network (5GCN) 106, one or more application functions (AF) 108 and one or more data networks (DN) 110.

An example 5G core network (CN) comprises functional entities. The 5GCN 106 may comprise one or more access and mobility management functions (AMF) 112, one or more session management functions (SMF) 114, an authentication server function (AUSF) 116, a unified data management (UDM) 118, one or more user plane functions (UPF) 120, a unified data repository (UDR) 122 and/or a network exposure function (NEF) 124. The UPF is controlled by the SMF (Session Management Function) that receives policies from a PCF (Policy Control Function).

The CN is connected to a UE via the radio access network (RAN). The 5GRAN may comprise one or more gNodeB (GNB) distributed unit functions connected to one or more gNodeB (GNB) centralized unit functions. The RAN may comprise one or more access nodes.

An UPF (User Plane Function) whose role is called PSA (PDU Session Anchor) may be responsible for forwarding frames back and forth between the DN (data network) and the tunnels established over the 5G towards the UE(s) exchanging traffic with the DN.

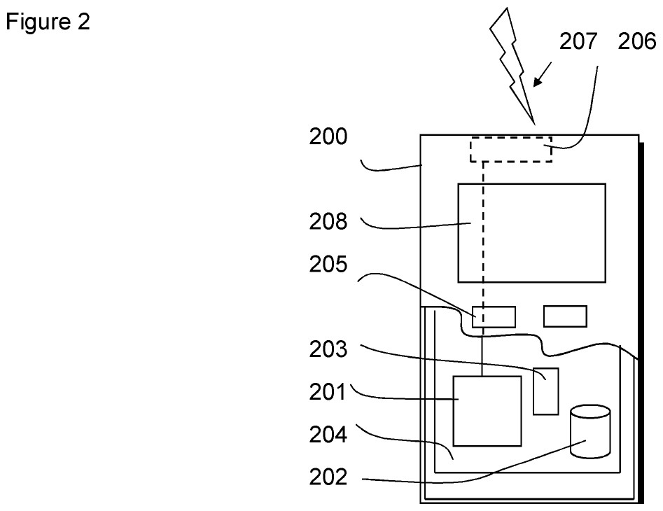

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

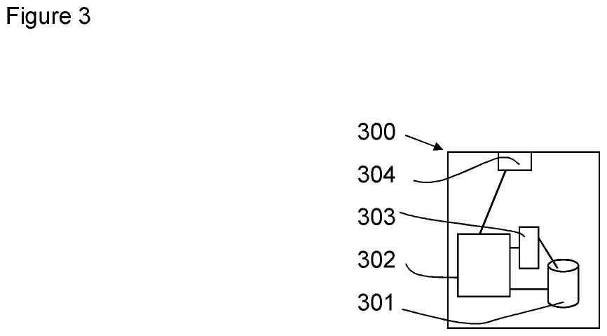

FIG. 3 shows an example embodiment of a control apparatus for a communication system, for example to be coupled to and/or for controlling a station of an access system, such as a RAN node, e.g. a base station, eNB or gNB, a relay node or a core network function such as AMF/SMF, or a server or host. The method may be implanted in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head.

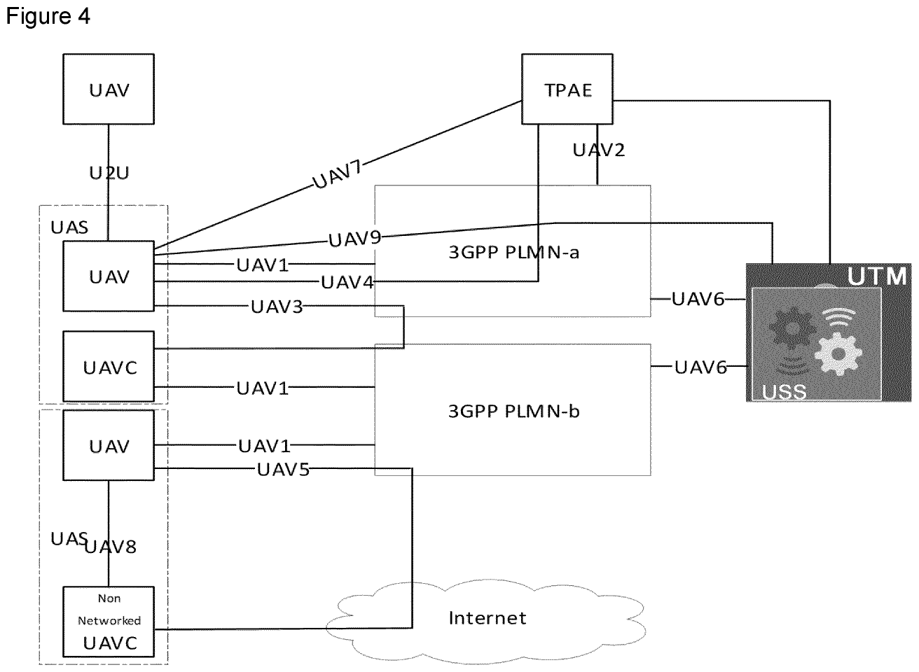

FIG. 4 shows a schematic diagram of an example architecture for unmanned aerial vehicle (UAV) control. An unmanned aerial system (UAS) may comprise one or more UAVs (also referred to as drones) and one UAVC (flight controller). 3GPP Rel-17 is working on enhancements for UAV control, including UAV identification, authentication, authorization and tracking. The UAVC may be networked or non-networked. A UAV may be connected to a UAS Traffic Management (UTM) through a 3GPP PLMN and/or via a Third Party Authorised Entity (TPAE).

The following may be requirements of a UAS:

1. To track UAVs, e.g. per tracking area, and be able to report to drone domain (e.g. UAS Traffic Management (UTM)/UAS Service Supplier (USS)).

2. To allow one UAV to advertise itself or send data to other UAVs in a certain area via the 3GPP network.

3. To allow authentication and authorization with the help of UTM/AF or USS, which is part of the UTM.

To allow efficient control of advertisements and/or broadcast messages from one UAV to other UAVs in the vicinity via the 3GPP network (either block these messages or allow them based on the given policy), it is beneficial for scenarios where UAVs are located in the same area to select the same SMF and/or UPF instances to serve certain UAVs (e.g. the ones belonging to the same UAS). To allow optimized and efficient delivery of control messages between a UAV and a UAVC (C2 communication), it may be beneficial for a UAV and a UAVC to be served by the same SMF and/or UPF instances so that there is no need for control messages to go through a data network.

In addition, selecting an UPF close to RAN may reduce latency for time critical communication between a UAV and UAVC.

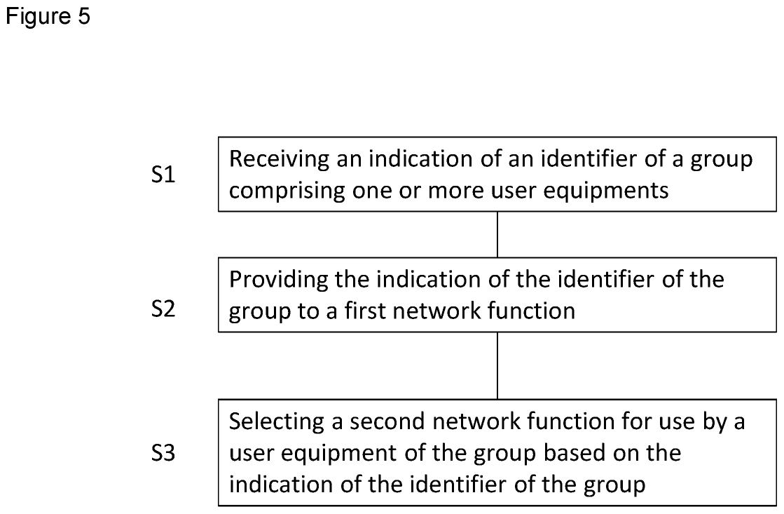

FIG. 5 shows a flowchart of a method according to an example embodiment. The method may be performed at an access and mobility management function (AMF).

In a first step, S1, the method comprises receiving an indication of an identifier of a group comprising one or more user equipments.

In a second step, S2, the method comprises providing the indication of the identifier of the group to a first network function.

In a third step, S3, the method comprises selecting a second network function for use by a user equipment based on the indication of the identifier of the group

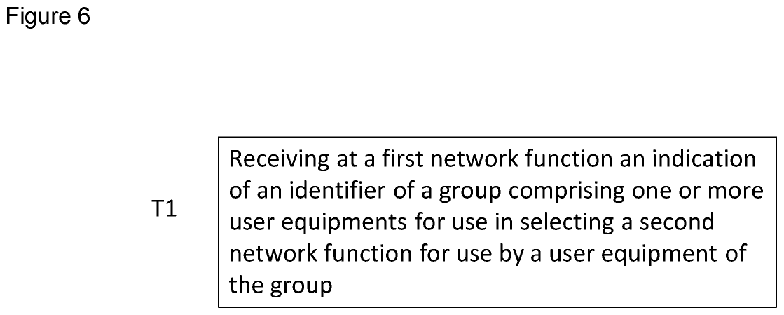

FIG. 6 shows a flowchart of a method according to an example embodiment. The method may be performed at the first network function, which may be a NRF or a UDSF.

In a first step, T1, the method comprises receiving at a first network function an indication of an identifier of a group comprising one or more user equipments for use in selecting a second network function for use by a user equipment.

A method as described with reference to FIG. 5 may comprise providing a discovery request including the indication of the identifier of the group to the first network function, receiving a profile of the second network function or context data of one user equipment of the group from the first network function and selecting the second network function based on the profile or the context data

A method as described with reference to FIG. 6 may comprise receiving a discovery request including the indication of the identifier of the group from a third network function, determining a profile of the second network function or context data of one user equipment of the group based on the recovery request and providing the profile of the second network function or context data of one user equipment of the group to the third network function.

The third network function may be an AMF.

The group may comprise one or more of an unmanned aerial vehicle, an unmanned aerial vehicle controller and a UAS. The UE may comprise a UAV or a UAVC. The identifier of the group may be a UAS ID or any other information that can be obtained from the UAS ID, for example, the identifier can identify a group of UASs. In one example embodiment, instead of the UAS ID, an identity identifying a group of UASs can be used. To facilitate this, the UAS ID can be designed so that a part of the UAS ID indicates a group of UASs.

The second network function may comprise a SMF or a UPF.

The method allows selection of the same SMF and/or UPF for UAV/UAVC(s) that share the same UAS ID or that belong to the same group of UASs. The UAS ID identifies a UAVC and UAV(s) controlled by this UAVC.

The method may comprise receiving an indication of the identifier at the AMF from one of UDM, the user equipment, a UAS Service Supplier, a UAS Application Server and a UAS Traffic Management.

For example, the UAS ID may be stored in the UDM.

Alternatively, or in addition, the UE (UAV or UAVC) may provide the UAS ID to the network. The indication of the identifier of the group may be received in a session establishment request from one user equipment of the group

In another example embodiment, the UAS ID may be provided to the 5GS from UTM/USS/AF after successful authentication and authorization. The indication of the identifier of the group is received from a network function during registration procedure of one user equipment of the group.

The method may comprise receiving at least one of an indication of a communication session type and a location of the user equipment.

The method may comprise selecting the second network function for use by the user equipment communication session type (e.g. that a PDU session is for C2 communication or communication with other UAVs) and the location of the user equipment.

The indication of the communication session type may correspond to one or more of S-NSSAI, DNN, and C2 communication indication.

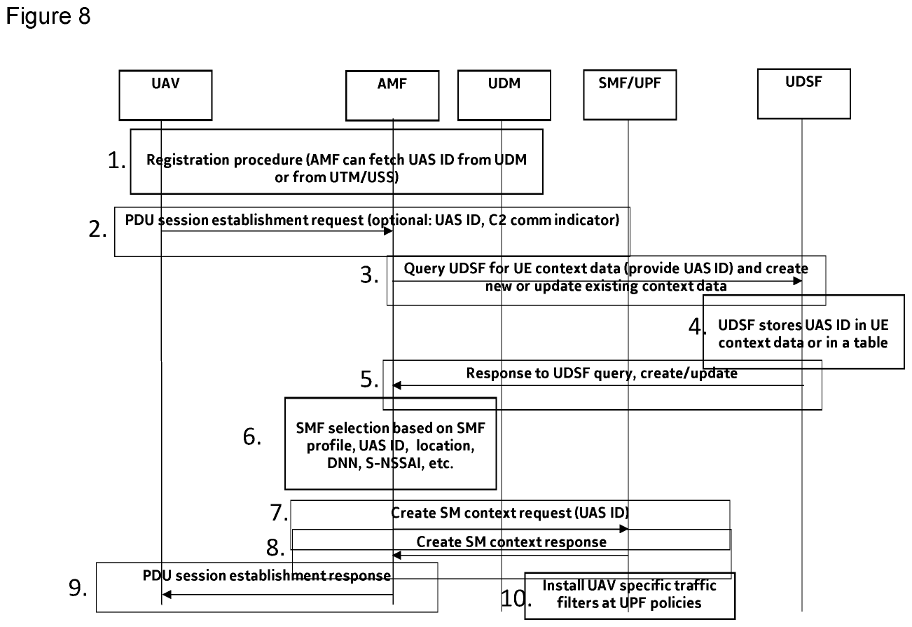

The indication of a communication session type may be realized by one bit or two bits (each bit indicating whether the PDU session is for C2 communication or whether the PDU session is for communication with UAVs in vicinity). Alternatively, the indication may be implemented by DNN, S-NSSAI or other type of an existing information element (or part of it).

Where UTM/USS/AF provides the UAS ID to 5GS and the authentication/authorization is carried out via the user plane, or the network triggers PDU session termination and re-establishment (in the case where the UAS ID is stored in UE context data and used for SMF selection later on as described with reference to FIG. 8), then the PDU session used for C2 communication and the PDU session used to carry application signaling for authentication/authorization are different.

To address this, a further parameter may be considered for SMF and/or UPF selection, an indication that the PDU session is for C2 communication or communication with UAVs in vicinity. A UAV or a UAVC may establish multiple PDU sessions and not all PDU sessions are for C2 communication or communication with UAVs in vicinity.

If known to the UE, the UE may indicate the UAS ID and/or the indication that the PDU session is for C2 communication or communication with UAVs in vicinity in a PDU session establishment request to the network.

Alternatively, or in addition, the AMF may receive the UAS ID after successful 3rd party authentication from UTM/USS/AF or from the UDM and may store it in UE context data either locally in AMF or in UDSF, if UDSF is deployed. If not received from UDM, the AMF may also store the UAS ID in UDM.

Based on UAS ID, the indication that the PDU session is for C2 communication or communication with UAVs in vicinity, and/or other parameter such as UE location (based on Cell ID, Tracking Area, geo-location), SMF and UPF are selected by the AMF.

The first network function may be a network repository function (NRF). The method may comprise storing the identifier and the associated second network function in a profile of the second network function or in a table.

In one example embodiment, to use the same SMF for all UAV(s) and UAVC identified by a UAS ID, when the PDU session is for C2 communication or communication with UAVs in vicinity, the first selected SMF updates its NRF profile by including UAS ID received from AMF. NRF may also maintain a table with SMF and/or UPF per UAS ID. For subsequent requests, the AMF selects the same SMF by considering UAS ID stored in NRF profile or in the NRF table.

The first network function may be an unstructured data storage function (UDSF). The method may comprise storing the identifier and the associated second network function in user equipment context data or in a table.

In an alternative example embodiment, if UDSF is deployed, the AMF stores the UAS ID and selected SMF in UE context data stored in UDSF. For subsequent requests, the AMF selects the same SMF by considering UAS ID, which may be received from UE or UDM, and is stored in UE context data in the UDSF.

The above example embodiments have been described with reference to SMF. For UPF selection, the SMF may use similar methods as described for SMF selection, i.e. store UAS

ID locally in SMF context data or centrally in UDSF, if UDSF is deployed. SMF may use the stored UAS ID together with the one received by AMF to select the same UPF for all UAV(s)/UAVC identified by the UAS ID.

Where the second network function is a UPF, the UPF may comprise a traffic filter policy.

Traffic filters may be installed at the UPF so that allowed UAV(s) can send messages to a given other UAV, e.g. messages from one UAV to others in the same UAS set. The PCF may provide these filters based on information received from UDM, from UTM/USS/AF via NEF or directly from UTM/USS/AF. Such policies may be provided via NEF to SMF and further on to the UPF. Policy in this context could mean that for UAV advertisements a special PDU session must be used, e.g. using a special DNN or S-NSSAI.

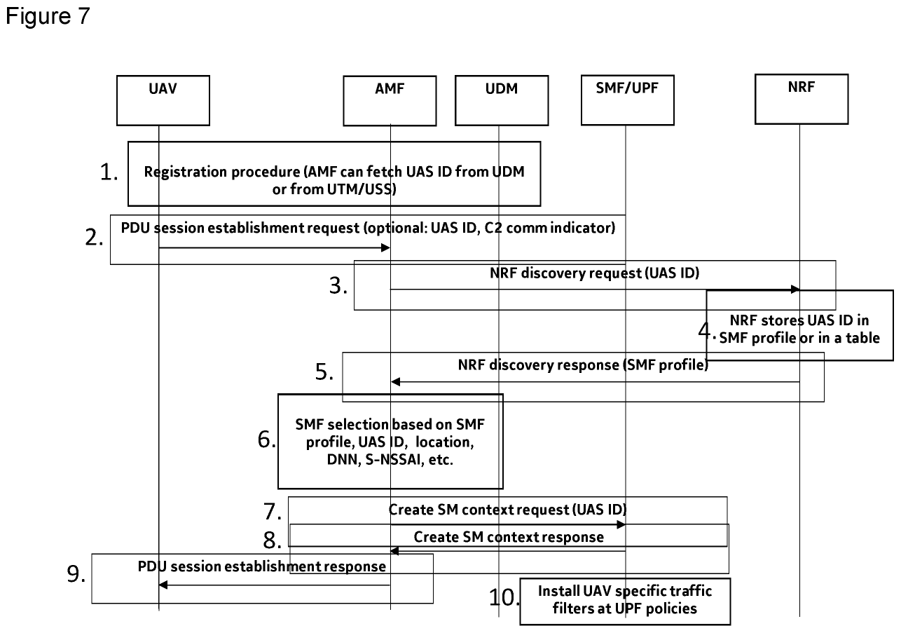

FIG. 7 shows a signalling flow between a UAV, AMF, UDM, SMF/UPF and NRF according to an example embodiment for selecting a SMF.

In step 1, the UAV performs a registration procedure with the AMF. The AMF may fetch the UAS ID from the UDM.

In step 2, the UAV sends a PDU session establishment request to the AMF. The PDU session establishment request may include the UAS ID and an indicator that the PDU session is for C2 communication.

In step 3, the AMF sends a NRF discovery request (including the UAS ID) to the NRF.

In step 4, the NRF stores the UAS ID in the SMF profile and in step 5, the NRF sends a NRF discovery response to the AMF (including the SMF profile).

In step 6, SMF selection based on the SMF profile, UAS ID, location, DNN S-NSSAI, etc. is performed at the AMF.

In Step 7, the AMF creates an SM context request (including the UAS ID) for the SMF/UPF and in step 8 received a SM context response from the SMF/UPF.

In step 9, the AMF sends a PDU session establishment response to the UAV.

In step 10, UAV specific traffic filters are installed at the UPF.

In this example embodiment, an initial SMF stores UAS ID for subsequent use in the NRF profile. The UAS ID is used in a subsequent look up to select the same SMF as before.

FIG. 8 shows a signalling flow according to an example embodiment for selecting a SMF, where a UDSF takes the place of NRF.

In this example embodiment, at step 3, the AMF queries the UDSF for UE context data (providing the UAS ID, if available, or a subscription identifier like the SUPI) and creates new context data or updates existing context data including UAS ID.

In step 4, the UDSF stores the UAS ID in the UE context data and in step 5, the UDSF provides a response to the UDSF query. UDSF may also maintain a table with SMF and/or UPF per UAS ID.

In step 6, SMF selection based on the SMF profile, UAS ID, location, DNN S-NSSAI, etc. is performed at the AMF.

The remaining steps are as described with reference to FIG. 7.

In this case the UE context data are stored in UDSF by the AMF and contain the UAS ID. AMF can use it when selecting the SMF, i.e. based on UAS ID assigned to the UE (e.g. received from UDM) and UAS ID stored in UE context data or in UDSF table, AMF can choose previously selected SMF during subsequent PDU session establishment request.

Not all messages are shown in the signalling flows shown in FIGS. 7 and 8, for more details see TS 23.502.

The above example embodiments refer to UAS ID. However, information such as special DNN, S-NSSAI or other indication can be used in place of UAS ID, which may then be stored in UDM and/or UE context data and potentially configured in the UE and provided by the UE to the network.

The concept of storing a certain indication/identifier in the NRF profile of a NF or in the UDSF context data to steer the NF selection process (here SMF, UPF selection) may be generalized beyond the UAV use case. Thus, the concept of optimized NF selection, e.g. selecting the same NF (such as SMF or UPF) for a group of UEs may be applicable in all cases where a certain identifier is assigned to a group of UE(s) (called group identifier).

The method may be implemented in a control apparatus as described with reference to FIG. 3.

An apparatus may comprise means for receiving an indication of an identifier of a group comprising one or more user equipments, providing the indication of the identifier of the group to a first network function and selecting a second network function for use by a user equipment of the group based on the indication of the identifier of the group.

Alternatively, or in addition, an apparatus may comprise means for receiving at a first network function an indication of an identifier of a group comprising one or more user equipments for use in selecting a second network function for use by a user equipment of the group.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to LTE and 5GS, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various example embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Example embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed, there is a further embodiment comprising a combination of one or more embodiments with any of the other embodiments previously discussed.

1-22. (canceled)

23. An apparatus comprising:
at least one processor;
at least one memory comprising computer program code, the at least one memory and computer program code configured to, with the at least one processor, cause the apparatus at least to:
receive an unmanned aerial vehicle system identifier for an unmanned aerial vehicle system comprising unmanned aerial vehicles and an unmanned aerial vehicle controller for controlling the unmanned aerial vehicles;
provide the unmanned aerial vehicle system identifier to a first network function of a core network, wherein the first network function is a network repository function or an unstructured data storage function; and
select a second network function of a core network for use by an unmanned aerial vehicle or the unmanned aerial vehicle controller of the unmanned aerial vehicle system based at least on the unmanned aerial vehicle system identifier, wherein the second network function is a session management function for the unmanned aerial vehicle system or a user plane function for the unmanned aerial vehicle system.

24. The apparatus according to claim 23, wherein the at least one memory and computer program code further configured to, with the at least one processor, cause the apparatus to provide the unmanned aerial vehicle system identifier to a first network function of a core network by:
providing a discovery request comprising the unmanned aerial vehicle system identifier to the first network function; and
receiving a profile of the second network function from the network repository function or the unstructured data storage function.

25. The apparatus according to claim 24, wherein the at least one memory and computer program code further configured to, with the at least one processor, cause the apparatus to select a second network function of a core network based at least on the unmanned aerial vehicle system identifier by:
selecting the second network function based on the profile of the second network function.

26. The apparatus according to claim 23, wherein the at least one memory and computer program code further configured to, with the at least one processor, cause the apparatus to provide the unmanned aerial vehicle system identifier to a first network function of a core network by:
providing a discovery request including the unmanned aerial vehicle system identifier to the first network function; and
receiving context data from the first network function, wherein the context data is associated with an unmanned aerial vehicle of the unmanned aerial vehicles or the unmanned aerial vehicle controller of the unmanned aerial vehicle system.

27. The apparatus according to claim 26, wherein the at least one memory and computer program code further configured to, with the at least one processor, cause the apparatus to select a second network function of a core network based at least on the unmanned aerial vehicle system identifier by:
selecting the second network function based on the received context data.

28. The apparatus according to claim 24, wherein the at least one memory and computer program code further configured to, with the at least one processor, cause the apparatus to receive by the unmanned aerial vehicle system identifier by receiving a request for establishment a protocol data unit session from an unmanned aerial vehicle of the unmanned aerial vehicles of the unmanned aerial vehicle system, the request comprising the unmanned aerial vehicle system identifier.

29. The apparatus according to claim 28, wherein request further comprises: a communication session type for the protocol data unit session and a location of the unmanned aerial vehicle.

30. The apparatus according to claim 29, wherein the at least one memory and computer program code further configured to, with the at least one processor, cause the apparatus to select the second network function for use by the user equipment by: selecting the second network function further based on at least one of the communication session type of the protocol data unit session and the location of the unmanned aerial vehicle.

31. The apparatus according to claim 30, wherein the communication session type indicates that the protocol data unit session is for communication between the or indicates that the protocol data unit session is for communication between the unmanned aerial vehicle and the unmanned aerial vehicle controller or for communication with one or more unmanned aerial vehicles in a vicinity of the unmanned aerial vehicle.

32. The apparatus according to claim 24, wherein the unmanned aerial vehicle system identifier is received from one of a unified data management function, an unmanned aerial vehicle of the unmanned aerial vehicles of the unmanned aerial vehicle system, the unmanned aerial vehicle controller, an unmanned aerial vehicle system service supplier, an unmanned aerial vehicle system application server, or an unmanned aerial vehicle system traffic management system.

33. An apparatus comprising:
at least one processor; and
at least one memory comprising computer program code, the at least one memory and computer program code configured to, with the at least one processor, cause the apparatus at least to:
receive a discovery request from an access and mobility function of a core network, the discovery request comprising an unmanned aerial vehicle system identifier for an unmanned aerial vehicle system comprising unmanned aerial vehicles and an unmanned aerial vehicle controller for controlling the unmanned aerial vehicles; and
determine a profile of a network function of a core network based on the unmanned aerial vehicle system identifier, wherein the network function is a session management function or a user plane function; and
provide the profile of the network function to the access and mobility function.

34. An apparatus comprising:
at least one processor; and
at least one memory comprising computer program code, the at least one memory and computer program code configured to, with the at least one processor, cause the apparatus at least to:
receive a query for context data for an unmanned aerial vehicle from an access and mobility function of a core network, the query comprising an unmanned aerial vehicle system identifier for an unmanned aerial vehicle system comprising unmanned aerial vehicles including the unmanned aerial vehicle and an unmanned aerial vehicle controller for controlling the unmanned aerial vehicles; and
obtain the context data for the unmanned aerial vehicle based on the unmanned aerial vehicle system identifier, the context data for the unmanned vehicle comprising an indication of a network function of the core network associated with the unmanned aerial vehicle system identifier, wherein the network function is a session management function or a user plane function; and
provide the context data for the unmanned aerial vehicle to the access and mobility function, receive a query from an access and mobility function of a core network, the query request comprising an unmanned aerial vehicle system identifier for an unmanned aerial vehicle system comprising unmanned aerial vehicles and an unmanned aerial vehicle controller for controlling the unmanned aerial vehicles; and
determine context data based at least on the unmanned aerial vehicle system identifier, wherein the network function is a session management function or a user plane function; and
provide the profile of the network function to the access and mobility function.
